(19) United States
(12) Patent Application Publication
(10) Pub. No.: US 2025/0007000 A1
(43) Pub. Date: Jan. 2, 2025

(54) ELECTROLYTIC SOLUTION FOR SECONDARY BATTERY, AND SECONDARY BATTERY

(71) Applicants: MURATA MANUFACTURING CO., LTD., Kyoto (JP); YOKOHAMA NATIONAL UNIVERSITY, Kanagawa (JP)

(72) Inventors: Hiroki MITA, Kyoto (JP); Kazunari MOTOHASHI, Kyoto (JP); Masayuki NAGAMINE, Kyoto (JP); Jusuke SHIMURA, Kyoto (JP); Kaoru DOKKO, Kyoto (JP); Masayoshi WATANABE, Kyoto (JP); Kazuhide UENO, Kyoto (JP)

(21) Appl. No.: 18/822,997

(22) Filed: Sep. 3, 2024

Related U.S. Application Data
(63) Continuation of application No. PCT/JP2023/010540, filed on Mar. 17, 2023.

(30) Foreign Application Priority Data
Mar. 28, 2022 (JP) 2022-051589

(51) Int. Cl. H01M 10/0569; H01M 10/0525; H01M 10/0567; H01M 10/0587

(52) U.S. Cl. CPC H01M 10/0569; H01M 10/0525; H01M 10/0567; H01M 10/0587

(57) ABSTRACT

An electrolytic solution for a secondary battery includes a lithium salt, a sulfonyl compound, and a fluorinated ether compound. The sulfonyl compound includes two or more selected from cyclic compounds and chain compounds. The sulfonyl compound includes at least one of the cyclic compounds. Each of the cyclic compounds is represented by Formula (1). Each of the chain compounds is represented by Formula (2). The fluorinated ether compound is represented by Formula (3). A concentration of the lithium salt is higher than or equal to 1.159 mol/L and lower than or equal to 3.592 moles per liter. A ratio of a number of moles of the sulfonyl compound to a number of moles of the lithium salt is greater than or equal to 2 and less than or equal to 4.

### CROSS-REFERENCE TO RELATED APPLICATIONS

The present application is a continuation of PCT Application No. PCT/JP2023/010540, filed on Mar. 17, 2023, which claims priority to Japanese Patent Application No. 2022-051589, filed on Mar. 28, 2022, the entire contents of which are incorporated herein by reference.

### BACKGROUND

The present disclosure relates to an electrolytic solution for a secondary battery, and to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution (an electrolytic solution for a secondary battery). A configuration of the secondary battery has been considered in various ways.

For example, an electrolytic solution includes a solvent for dissolving an electrolyte salt, and an electrolyte salt. The solvent for dissolving an electrolyte salt includes a predetermined amount of a sulfolane compound.

### SUMMARY

An electrolytic solution for a secondary battery according to an embodiment of the present disclosure includes a lithium salt, a sulfonyl compound, and a fluorinated ether compound. The sulfonyl compound includes two or more selected from cyclic compounds and chain compounds. The sulfonyl compound includes at least one of the cyclic compounds. Each of the cyclic compounds is represented by Formula (1). Each of the chain compounds is represented by Formula (2). The fluorinated ether compound is represented by Formula (3). A concentration of the lithium salt is higher than or equal to 1.159 mol/L and lower than or equal to 3.592 mol/L. A ratio of a number of moles of the sulfonyl compound to a number of moles of the lithium salt is greater than or equal to 2 and less than or equal to 4.

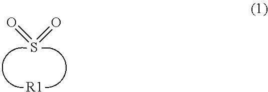

where R1 is an alkylene group.

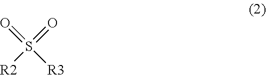

where each of R2 and R3 is an alkyl group.

R4-O—R5 (3)

where each of R4 and R5 is a fluorinated alkyl group.

A secondary battery according to an embodiment of the present disclosure includes a positive electrode, a negative electrode, and an electrolytic solution. The electrolytic solution includes a lithium salt, a sulfonyl compound, and a fluorinated ether compound. The sulfonyl compound includes two or more selected from cyclic compounds and chain compounds. The sulfonyl compound includes at least one of the cyclic compounds. Each of the cyclic compounds is represented by Formula (1). Each of the chain compounds is represented by Formula (2). The fluorinated ether compound is represented by Formula (3). A concentration of the lithium salt is higher than or equal to 1.159 mol/L and lower than or equal to 3.592 mol/L. A ratio of a number of moles of the sulfonyl compound to a number of moles of the lithium salt is greater than or equal to 2 and less than or equal to 4.

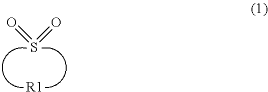

where R1 is an alkylene group.

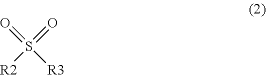

where each of R2 and R3 is an alkyl group.

R4-O—R5 (3)

where each of R4 and R5 is a fluorinated alkyl group.

### BRIEF DESCRIPTION OF THE FIGURES

The accompanying drawings are included to provide a further understanding of the present disclosure and are incorporated in and constitute a part of this specification. The drawings illustrate embodiments and, together with the specification, serve to explain the principles of the present disclosure.

FIG. 1 is a sectional diagram illustrating a configuration of a secondary battery according to an embodiment of the present disclosure.

FIG. 2 is a sectional diagram illustrating a configuration of a battery device illustrated in FIG. 1.

FIG. 3 is a block diagram illustrating a configuration of an application example of the secondary battery.

FIG. 4 is a sectional diagram illustrating a configuration of a test secondary battery.

### DETAILED DESCRIPTION

Consideration has been given in various ways to improve a battery characteristic of a secondary battery. However, the battery characteristic of the secondary battery is still insufficient, and there is room for improvement in terms of the battery characteristic.

It is desirable to provide an electrolytic solution for a secondary battery, and a secondary battery that each make it possible to achieve a superior battery characteristic.

In the following, some embodiments of the present disclosure are described in detail with reference to the accompanying drawings. Note that the following description is directed to illustrative examples of the present disclosure and not to be construed as limiting to the present disclosure. Factors including, without limitation, numerical values, shapes, materials, components, positions of the components, and how the components are coupled to each other are illustrative only and not to be construed as limiting to the present disclosure. Further, elements in the following embodiments which are not recited in a most-generic independent claim of the present disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the present disclosure are unillustrated in the drawings.

A description is given first of an electrolytic solution for a secondary battery according to an example embodiment of the present disclosure. Hereinafter, the electrolytic solution for a secondary battery according to an embodiment of the present disclosure is simply referred to as the “electrolytic solution”.

The electrolytic solution described here may be a liquid electrolyte to be used in a secondary battery, which is an electrochemical device. In an embodiment, however, the electrolytic solution may be used in other electrochemical devices. Non-limiting examples of the other electrochemical devices may include a capacitor.

The electrolytic solution includes a lithium salt and a sulfonyl compound. For example, the sulfonyl compound may serve as a solvent that dissolves or disperses the lithium salt. For example, the lithium salt may serve as an electrolyte salt that is ionized in the solvent.

As described above, the electrolytic solution may include the sulfonyl compound as the solvent that dissolves or disperses the lithium salt as the electrolyte salt, and may therefore include no typical solvent.

The typical solvent may refer to a solvent to be typically used in an electrolytic solution for a secondary battery. The typical solvent may be, for example but not limited to, any of esters and ethers to be described later. Non-limiting examples of the esters and ethers may include a carbonic-acid-ester-based compound, a carboxylic-acid-ester-based compound, and a lactone-based compound.

The carbonic-acid-ester-based compound may be, for example but not limited to, a cyclic carbonic acid ester or a chain carbonic acid ester. Non-limiting examples of the cyclic carbonic acid ester may include ethylene carbonate and propylene carbonate. Non-limiting examples of the chain carbonic acid ester may include dimethyl carbonate, diethyl carbonate, and ethyl methyl carbonate.

The carboxylic-acid-ester-based compound may be, for example but not limited to, a chain carboxylic acid ester. Non-limiting examples of the chain carboxylic acid ester may include ethyl acetate, ethyl propionate, propyl propionate, and ethyl trimethylacetate.

The lactone-based compound may be, for example but not limited to, a lactone. Non-limiting examples of the lactone may include γ-butyrolactone and γ-valerolactone.

The term “lithium salt” may be a general term for a salt including a lithium ion as a cation. In an embodiment, one lithium salt may be used. In an embodiment, two or more lithium salts may be used.

The lithium salt is not particularly limited in kind. Non-limiting examples of the lithium salt may include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium difluorooxalatoborate (LiBF₂(C₂O₄)), lithium difluorodi(oxalato)borate (LiPF₂(C₂O₄)₂), lithium tetrafluorooxalatophosphate (LiPF₄(C₂O₄)), lithium monofluorophosphate (Li₂PFO₃), and lithium difluorophosphate (LiPF₂O₂). In an embodiment, a concentration of the lithium salt may be higher than or equal to 1.159 mol/L and lower than or equal to 3.592 mol/L. In an embodiment, the concentration of the lithium salt may be higher than or equal to 1.159 mol/L and lower than or equal to 3.354 mol/L. In an embodiment, the concentration of the lithium salt may be higher than or equal to 1.159 mol/L and lower than or equal to 2.025 mol/L.

The term “sulfonyl compound” may be a generic term for a compound including a sulfonyl group (—S(═O)₂—). In an embodiment, one sulfonyl compound may be used. In an embodiment, two or more sulfonyl compounds may be used.

The sulfonyl compound includes two or more selected from cyclic compounds and chain compounds. Each of the chain compounds is represented by Formula (1). Each of the chain compounds is represented by Formula (2). In an embodiment, the sulfonyl compound may include at least one of the cyclic compounds.

In an embodiment, the sulfonyl compound may include two or more of the cyclic compounds, and may therefore include no chain compound. In an embodiment, the sulfonyl compound may include two or more of the chain compounds, and may therefore include no cyclic compound. In an embodiment, the sulfonyl compound may include one or more of the cyclic compounds and one or more of the chain compounds together.

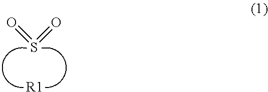

where R1 is an alkylene group.

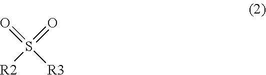

where each of R2 and R3 is an alkyl group.

One reason why the sulfonyl compound includes two or more selected from the cyclic compounds and the chain compounds is that this helps to allow the lithium salt to be dissolved more easily and more stably by the sulfonyl compound, as compared with when the sulfonyl compound includes any one selected from the cyclic compounds and the chain compounds. This helps to prevent a mixture of the lithium salt and the sulfonyl compound from becoming solid and to allow the mixture to become liquid. This helps to allow the mixture to be usable as an electrolytic solution.

The cyclic compounds may each be a cyclic compound including a sulfonyl group, as described in Formula (1).

Carbon number of the alkylene group is not particularly limited and may be any number. The alkylene group may have a straight-chain structure, or may have a branched structure with one or more side chains.

Non-limiting examples of the alkylene group may include an ethylene group, a propylene group, a butylene group, and a pentylene group. The pentylene group may be, for example but not limited to, an n-pentylene group, an isopentylene group, a sec-pentylene group, a 3-pentylene group, a tert-pentylene group, or a neopentylene group.

In an embodiment, the carbon number of the alkylene group may be 5 or less. One reason for this is that the carbon number of the alkylene group being not too large helps to allow the lithium salt to be dissolved sufficiently by the sulfonyl compound.

Non-limiting examples of the cyclic compounds may include: sulfolane (when R1 is an n-butylene group, i.e., what is called a tetramethylene group); 3-methylsulfolane (when R1 is an isopentylene group); and trimethylene sulfone (when R1 is an n-propylene group, i.e., what is called a trimethylene group).

The chain compounds may each be a chain compound including a sulfonyl group, as described in Formula (2). R2 and R3 may be of the same kind, or may be of respective kinds different from each other.

Carbon number of the alkyl group is not particularly limited and may be any number. The alkyl group may have a straight-chain structure, or may have a branched structure with one or more side chains.

Non-limiting examples of the alkyl group may include a methyl group, an ethyl group, a propyl group, and a butyl group. The butyl group may be, for example but not limited to, an n-butyl group, an isobutyl group, a sec-butyl group, or a tert-butyl group.

In an embodiment, the carbon number of the alkyl group may be 2 or less. One reason for this is that the carbon number of the alkyl group being not too large helps to allow the lithium salt to be dissolved sufficiently by the sulfonyl compound.

Non-limiting examples of the chain compounds may include: dimethyl sulfone (when R2 is a methyl group and R3 is a methyl group); diethyl sulfone (when R2 is an ethyl group and R3 is an ethyl group); ethyl methyl sulfone (when R2 is an ethyl group and R3 is a methyl group); and ethyl isopropyl sulfone (when R2 is an ethyl group and R3 is an isopropyl group).

A relationship between a content of the lithium salt in the electrolytic solution and a content of the sulfonyl compound in the electrolytic solution may be made appropriate.

A molar ratio M that is a ratio of a number of moles M2 of the sulfonyl compound to a number of moles M1 of the lithium salt is within a range from 2 to 4 both inclusive. One reason for this is that when the lithium salt and the sulfonyl compound are used in combination, the relationship between the content of the lithium salt and the content of the sulfonyl compound is made appropriate, which helps to allow the lithium salt to be dissolved more easily and more stably by the sulfonyl compound. As described above, this helps to prevent the mixture of the lithium salt and the sulfonyl compound from becoming solid and to allow the mixture to become liquid, which helps to allow the mixture to be usable as an electrolytic solution. The molar ratio M may be calculated based on the following calculation expression: M=M2/M1.

The following may be an example procedure for calculating the molar ratio M. First, an electrolytic solution may be prepared. When a secondary battery including an electrolytic solution is used, the electrolytic solution may be collected by disassembling the secondary battery. Thereafter, the electrolytic solution may be analyzed by inductively coupled plasma (ICP) optical emission spectroscopy to thereby determine the content (i.e., the number of moles M1) of the lithium salt and the content (i.e., the number of moles M2) of the sulfonyl compound. Thereafter, the molar ratio M may be calculated by the above-described calculation expression, based on the determined number of moles M1 and the determined number of moles M2.

In an embodiment, the sulfonyl compound may include two of the cyclic compounds. One reason for this is that this helps to allow the lithium salt to be dissolved more sufficiently by the sulfonyl compound.

In an embodiment, the sulfonyl compound may include sulfolane. In an embodiment, the sulfonyl compound may include sulfolane as one of the two cyclic compounds. One reason for this is that this helps to allow the lithium salt to be dissolved more stably by the sulfonyl compound.

In this case, in an embodiment, the sulfonyl compound may further include a derivative of sulfolane. In an embodiment, the sulfonyl compound may include the derivative of sulfolane as another of the two cyclic compounds. One reason for this is that this helps to allow the lithium salt to be dissolved more stably by the sulfonyl compound.

The derivative of sulfolane may be a compound having a skeleton similar to that of sulfolane. Non-limiting examples of such a derivative of sulfolane may include 3-methylsulfolane.

When the sulfonyl compound includes two of the cyclic compounds, the molar ratio M is within the range from 2 to 4 both inclusive, as described above.

In an embodiment, the sulfonyl compound may include one of the cyclic compounds and one of the chain compounds. One reason for this is that this helps to allow the lithium salt to be dissolved more sufficiently by the sulfonyl compound.

In an embodiment, the sulfonyl compound may include sulfolane. In an embodiment, the sulfonyl compound may include sulfolane as the cyclic compound. One reason for this is that this helps to allow the lithium salt to be dissolved more stably by the sulfonyl compound.

In this case, the chain compound is not particularly limited in kind, and may be chosen as desired. One reason for this is that the sulfonyl compound including sulfolane as the cyclic compound helps to allow the lithium salt to be dissolved more stably by the sulfonyl compound, regardless of the kind of the chain compound.

In an embodiment, the sulfonyl compound may include dimethyl sulfone, ethyl methyl sulfone, or both, as one or more chain compounds. One reason for this is that this helps to allow the lithium salt to be dissolved more stably by the sulfonyl compound.

When the sulfonyl compound includes one of the cyclic compounds and one of the chain compounds, the molar ratio M is within the range from 2 to 4 both inclusive, as described above.

In an embodiment, the electrolytic solution may further include any one or more of additives. The one or more additives are not particularly limited in kind, and may be chosen as desired.

In an embodiment, the one or more additives may include a fluorinated ether compound represented by Formula (3). One reason for this is that this helps to decrease a viscosity of the electrolytic solution. In an embodiment, one fluorinated ether compound may be used. In an embodiment two or more fluorinated ether compounds may be used.

R4-O—R5 (3)

where each of R4 and R5 is a fluorinated alkyl group.

The fluorinated ether compound may be a compound in which two fluorinated alkyl groups (i.e., R4 and R5) are bonded to each other via an ether bond (—O—), as described in Formula (3). R4 and R5 may be of the same kind, or may be of respective kinds different from each other.

A fluorinated alkyl group may have a configuration similar to that of an alkyl group, except that one or more of hydrogen atoms in the alkyl group are substituted with one or more fluorine atoms. In an embodiment, a part of the hydrogen atoms in the alkyl group may be substituted with one or more fluorine atoms, in which case, the fluorinated alkyl group may be referred to as a partially-substituted-type fluorinated alkyl group. In an embodiment, all of the hydrogen atoms in the alkyl group may be substituted with fluorine atoms, in which case, the fluorinated alkyl group may be referred to as an all-substituted-type fluorinated alkyl group. The all-substituted-type fluorinated alkyl group may be what is called a perfluoroalkyl group. Details of the alkyl group may be as described above, for example.

Carbon number of the fluorinated alkyl group is not particularly limited, and may be any number. The fluorinated alkyl group may have a straight-chain structure, or may have a branched structure with one or more side chains.

Non-limiting examples of the fluorinated alkyl group may include a partially-substituted-type methyl group, an all-substituted-type methyl group, a partially-substituted-type ethyl group, an all-substituted-type ethyl group, a partially-substituted-type propyl group, an all-substituted-type propyl group, a partially-substituted-type butyl group, and an all-substituted-type butyl group.

In an embodiment, the carbon number of the fluorinated alkyl group may be 3 or less. In an embodiment, the carbon number of the fluorinated alkyl group may be 2 or less. One reason for this is that the carbon number of the fluorinated alkyl group being not too large helps to improve compatibility of the fluorinated ether compound.

Non-limiting examples of the fluorinated ether compound may include hydrofluoroether having a configuration represented by CHF₂—CF₂—O—CH₂—CF₂—CHF₂ (when R4 is —CF₂—CHF₂ and R5 is —CH₂—CF₂—CHF₂).

A content of the fluorinated ether compound in the electrolytic solution is not particularly limited, and may be set as desired.

In an embodiment, the one or more additives may include a fluorinated cyclic carbonic acid ester. One reason for this is that during charging and discharging of the secondary battery including the electrolytic solution, a film derived from the fluorinated cyclic carbonic acid ester is formed on a surface of the negative electrode, which suppresses a decomposition reaction of the electrolytic solution. In an embodiment, one fluorinated cyclic carbonic acid ester may be used. In an embodiment, two or more fluorinated cyclic carbonic acid esters may be used.

The fluorinated cyclic carbonic acid ester may be a cyclic carbonic acid ester including fluorine as a constituent element. The number of fluorine atoms is not particularly limited, and may be one, or two or more. The fluorinated cyclic carbonic acid ester may have a configuration similar to that of the cyclic carbonic acid ester, except that one or more of hydrogen atoms in the cyclic carbonic acid ester are substituted with one or more fluorine atoms.

Non-limiting examples of the fluorinated cyclic carbonic acid ester may include fluoroethylene carbonate. A content of the fluorinated cyclic carbonic acid ester in the electrolytic solution is not particularly limited, and may be set as desired.

In an embodiment, the one or more additives may include an unsaturated cyclic carbonic acid ester. One reason for this is that during charging and discharging of the secondary battery including the electrolytic solution, a film derived from the unsaturated cyclic carbonic acid ester is formed on a surface of the negative electrode, which suppresses the decomposition reaction of the electrolytic solution. In an embodiment where the fluorinated cyclic carbonic acid ester and the unsaturated cyclic carbonic acid ester are used in combination, a favorable film may be formed. This helps to further suppress the decomposition reaction of the electrolytic solution. In an embodiment, one unsaturated cyclic carbonic acid ester may be used. In an embodiment, two or more unsaturated cyclic carbonic acid esters may be used.

The unsaturated cyclic carbonic acid ester may be a cyclic carbonic acid ester having an unsaturated carbon bond (a carbon-carbon double bond). The number of unsaturated carbon bonds is not particularly limited, and may be only one, or two or more.

Non-limiting examples of the unsaturated cyclic carbonic acid ester may include vinylene carbonate. A content of the unsaturated cyclic carbonic acid ester in the electrolytic solution is not particularly limited, and may be set as desired.

In an embodiment, other than the above, the one or more additives may include any one or more of butylene carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutaronitrile, adiponitrile, methoxyacetonitrile, 3-methoxypropylonitrile, N,N-dimethylformamide, N-methylpyrrolidinone, N-methyloxazolidinone, N,N-dimethylimidazolidinone, nitromethane, nitroethane, dimethyl sulfoxide, trimethyl phosphate, and any other suitable material. One reason for this is that during charging and discharging of the secondary battery including the electrolytic solution, a film is formed on the surface of the negative electrode, which suppresses the decomposition reaction of the electrolytic solution.

The one or more additives described above are merely optional components. Therefore, the electrolytic solution may include the one or more additives, or may include no additives. Accordingly, as described above, the electrolytic solution does not have to include the typical solvent as long as the electrolytic solution includes the sulfonyl compound that serves as the solvent dissolving or dispersing the lithium salt.

When manufacturing the electrolytic solution, the lithium salt may be put into the sulfonyl compound. In this case, the one or more additives including, without limitation, the fluorinated ether compound, the fluorinated cyclic carbonic acid ester, or both may be further added to the sulfonyl compound. The lithium salt may thus be dissolved or dispersed in the sulfonyl compound. As a result, the electrolytic solution may be prepared.

The electrolytic solution includes the lithium salt and the sulfonyl compound. The sulfonyl compound includes two or more selected from the cyclic compounds and the chain compounds. The molar ratio M is within the range from 2 to 4 both inclusive.

In this case, the sulfonyl compound including two or more selected from the cyclic compounds and the chain compounds helps to allow the lithium salt to be dissolved easily and stably by the sulfonyl compound, as described above. This helps to prevent the mixture of the lithium salt and the sulfonyl compound from becoming solid and to allow the mixture to become liquid.

Further, the molar ratio M being made appropriate helps to allow the lithium salt to be dissolved more easily and more stably by the sulfonyl compound, as described above. This helps to allow the mixture of the lithium salt and the sulfonyl compound to more stably become liquid.

The above-described points help to allow the mixture of the lithium salt and the sulfonyl compound to be usable as an electrolytic solution, which helps to provide a secondary battery including the electrolytic solution. In this case, the state of the electrolytic solution is easily maintained, or the electrolytic solution is easily maintained to be liquid. Accordingly, the use of such an electrolytic solution helps to provide a secondary battery having a superior battery characteristic.

In an embodiment, the sulfonyl compound may include two of the cyclic compounds. This helps to allow the lithium salt to be dissolved sufficiently by the sulfonyl compound, and to thereby achieve higher effects.

In an embodiment where the sulfonyl compound includes two of the cyclic compounds as described above, the sulfonyl compound may include sulfolane. This helps to allow the lithium salt to be dissolved more stably by the sulfonyl compound, and to thereby achieve further higher effects. In an embodiment, the sulfonyl compound may further include 3-methylsulfolane. This helps to allow the lithium salt to be dissolved more stably by the sulfonyl compound, and to thereby achieve markedly higher effects.

In an embodiment, the sulfonyl compound may include one of the cyclic compounds and one of the chain compounds. This helps to allow the lithium salt to be dissolved sufficiently by the sulfonyl compound, and to thereby achieve higher effects.

In an embodiment where the sulfonyl compound includes one of the cyclic compounds and one of the chain compounds as described above, the sulfonyl compound may include sulfolane. This helps to allow the lithium salt to be dissolved more stably by the sulfonyl compound, and to thereby achieve further higher effects. In an embodiment, the sulfonyl compound may further include dimethyl sulfone, ethyl methyl sulfone, or both. This helps to allow the lithium salt to be dissolved more stably by the sulfonyl compound, and to thereby achieve markedly higher effects.

In an embodiment, the electrolytic solution may further include the fluorinated ether compound. This helps to decrease the viscosity of the electrolytic solution, and to thereby achieve higher effects.

In an embodiment, the electrolytic solution may further include the fluorinated cyclic carbonic acid ester. This helps to suppress the decomposition reaction of the electrolytic solution during charging and discharging of the secondary battery including the electrolytic solution, and to thereby achieve higher effects.

A description is given next of a secondary battery including the electrolytic solution described above according to an embodiment.

The secondary battery to be described here may be a secondary battery in which a battery capacity is obtained through insertion and extraction of an electrode reactant. The secondary battery includes a positive electrode, a negative electrode, and the electrolytic solution.

In the secondary battery, a charge capacity of the negative electrode may be greater than a discharge capacity of the positive electrode. For example, an electrochemical capacity per unit area of the negative electrode may be set to be greater than an electrochemical capacity per unit area of the positive electrode. This is to help to prevent precipitation of the electrode reactant on a surface of the negative electrode during charging.

The electrode reactant is not particularly limited in kind, and may be, for example but not limited to, a light metal such as an alkali metal or an alkaline earth metal. Non-limiting examples of the alkali metal may include lithium, sodium, and potassium. Non-limiting examples of the alkaline earth metal may include beryllium, magnesium, and calcium. In an embodiment, the electrode reactant may be another light metal such as aluminum.

Described below is an example case where the electrode reactant is lithium. A secondary battery in which the battery capacity is obtained through insertion and extraction of lithium may be what is called a lithium-ion secondary battery. In the lithium-ion secondary battery, lithium may be inserted and extracted in an ionic state.

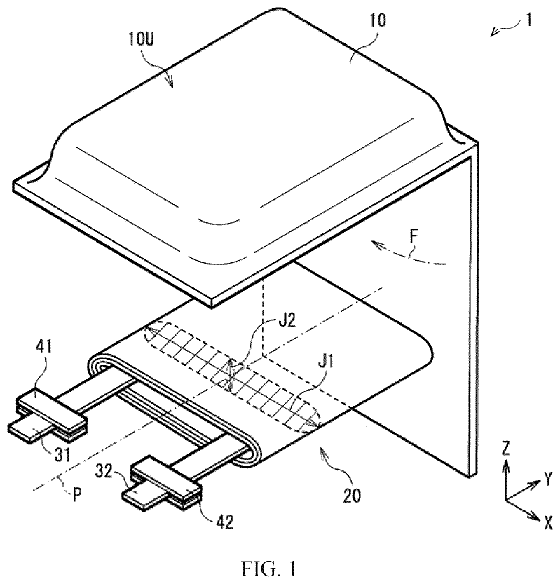

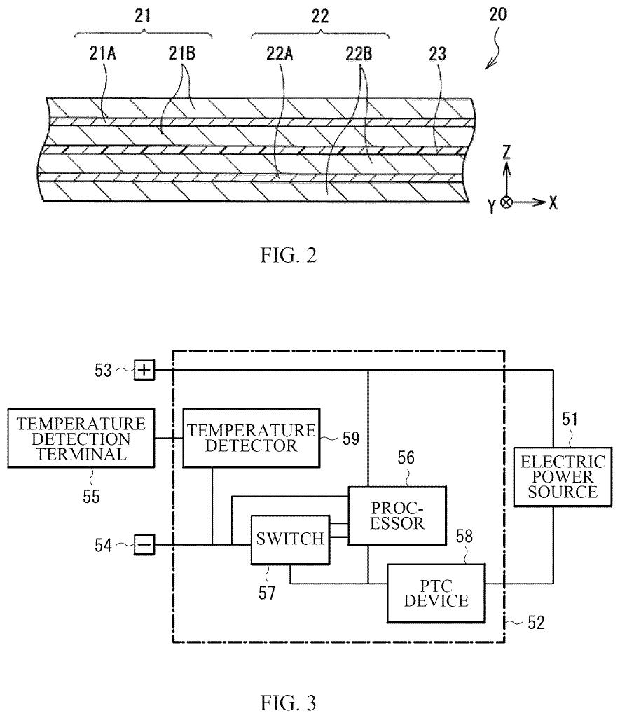

FIG. 1 illustrates a perspective configuration of a secondary battery 1 including the electrolytic solution described above. FIG. 2 illustrates a sectional configuration of a battery device 20 illustrated in FIG. 1. Note that FIG. 1 illustrates a state in which an outer package film 10 and the battery device 20 are separated from each other, and illustrates a section of the battery device 20 along an XZ plane by a dashed line. FIG. 2 illustrates a portion of the battery device 20.

As illustrated in FIGS. 1 and 2, the secondary battery 1 may include the outer package film 10, the battery device 20, a positive electrode lead 31, a negative electrode lead 32, and sealing films 41 and 42. The secondary battery 1 described here may be a secondary battery of a laminated-film type in which the outer package film 10 having flexibility or softness is used.

As illustrated in FIG. 1, the outer package film 10 may be an outer package member that contains the battery device 20. The outer package film 10 may have a pouch-shaped structure that is sealed in a state where the battery device 20 is contained inside the outer package film 10. The outer package film 10 may thus contain a positive electrode 21 and a negative electrode 22 to be described later, and the electrolytic solution.

For example, the outer package film 10 may be a single film-shaped member and may be folded toward a folding direction F. The outer package film 10 may have a depression part 10U to place the battery device 20 therein. The depression part 10U may be what is called a deep drawn part.

For example, the outer package film 10 may be a three-layered laminated film including a fusion-bonding layer, a metal layer, and a surface protective layer stacked in this order from an inner side. In a state where the outer package film 10 is folded, outer edge parts of the fusion-bonding layer opposed to each other may be fusion-bonded to each other. The fusion-bonding layer may include a polymer compound such as polypropylene. The metal layer may include a metal material such as aluminum. The surface protective layer may include a polymer compound such as nylon.

Note that the outer package film 10 is not particularly limited in configuration or the number of layers, and may be single-layered or two-layered, or may include four or more layers.

As illustrated in FIGS. 1 and 2, the battery device 20 may be a power generation device that includes the positive electrode 21, the negative electrode 22, a separator 23, and the electrolytic solution (not illustrated). The battery device 20 may be contained inside the outer package film 10.

The battery device 20 may be what is called a wound electrode body. For example, the positive electrode 21 and the negative electrode 22 may be stacked on each other with the separator 23 interposed therebetween, and may be wound about a winding axis P in a state where the positive electrode 21 and the negative electrode 22 are opposed to each other with the separator 23 interposed therebetween. The winding axis P may be a virtual axis extending in a Y-axis direction.

The battery device 20 is not particularly limited in three-dimensional shape, and may have any three-dimensional shape. For example, the battery device 20 may have an elongated three-dimensional shape. Accordingly, a section of the battery device 20 intersecting the winding axis P, i.e., the section of the battery device 20 along the XZ plane, may have an elongated shape defined by a major axis J1 and a minor axis J2. The major axis J1 may be a virtual axis that extends in an X-axis direction and has a larger length than the minor axis J2. The minor axis J2 may be a virtual axis that extends in a Z-axis direction intersecting the X-axis direction and has a smaller length than the major axis J1. In the present example embodiment, the battery device 20 may have an elongated cylindrical three-dimensional shape. Thus, the section of the battery device 20 may have an elongated, substantially elliptical shape.

The positive electrode 21 may include, as illustrated in FIG. 2, a positive electrode current collector 21A and a positive electrode active material layer 21B.

The positive electrode current collector 21A may have two opposed surfaces on each of which the positive electrode active material layer 21B is to be provided. The positive electrode current collector 21A may include an electrically conductive material such as a metal material. Non-limiting examples of the electrically conductive material may include aluminum.

The positive electrode active material layer 21B may include any one or more of positive electrode active materials into which lithium is insertable and from which lithium is extractable. In an embodiment, the positive electrode active material layer 21B may further include any one or more of other materials including, without limitation, a positive electrode binder and a positive electrode conductor.

For example, the positive electrode active material layer 21B may be provided on each of the two opposed surfaces of the positive electrode current collector 21A. In an embodiment, however, the positive electrode active material layer 21B may be provided on one of the two opposed surfaces of the positive electrode current collector 21A on a side where the positive electrode 21 is opposed to the negative electrode 22. A method of forming the positive electrode active material layer 21B is not particularly limited, and non-limiting examples thereof may include a coating method.

The positive electrode active material is not particularly limited in kind, and non-limiting examples thereof may include a lithium-containing compound. The lithium-containing compound may be a compound that includes lithium and one or more transition metal elements as constituent elements. In an embodiment, the lithium-containing compound may further include one or more other elements as one or more constituent elements. The one or more other elements are not particularly limited in kind as long as the one or more other elements are each an element other than lithium and the transition metal elements. The one or more other elements may be, for example but not limited to, any one or more of elements belonging to groups 2 to 15 in the long period periodic table. The lithium-containing compound is not particularly limited in kind, and may be, for example but not limited to, an oxide, a phosphoric acid compound, a silicic acid compound, or a boric acid compound.

Non-limiting examples of the oxide may include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Non-limiting examples of the phosphoric acid compound may include LiFePO₄, LiMnPO₄, LiFe_{0.5}Mn_{0.5}PO₄, and LiFe_{0.3}Mn_{0.7}PO₄.

The positive electrode binder may include any one or more of materials including, without limitation, a synthetic rubber and a polymer compound. Non-limiting examples of the synthetic rubber may include a styrene-butadiene-based rubber, a fluorine-based rubber, and ethylene propylene diene. Non-limiting examples of the polymer compound may include polyvinylidene difluoride, polyimide, and carboxymethyl cellulose.

The positive electrode conductor may include any one or more of electrically conductive materials including, without limitation, a carbon material. Non-limiting examples of the carbon material may include graphite, carbon black, acetylene black, and Ketjen black. In an embodiment, the electrically conductive material may be a metal material or a polymer compound.

The negative electrode 22 may include, as illustrated in FIG. 2, a negative electrode current collector 22A and a negative electrode active material layer 22B.

The negative electrode current collector 22A may have two opposed surfaces on each of which the negative electrode active material layer 22B is to be provided. The negative electrode current collector 22A may include an electrically conductive material such as a metal material. Non-limiting examples of the electrically conductive material include copper.

The negative electrode active material layer 22B may include any one or more of negative electrode active materials into which lithium is insertable and from which lithium is extractable. In an embodiment, the negative electrode active material layer 22B may further include any one or more of other materials including, without limitation, a negative electrode binder and a negative electrode conductor.

For example, the negative electrode active material layer 22B may be provided on each of the two opposed surfaces of the negative electrode current collector 22A. In an embodiment, however, the negative electrode active material layer 22B may be provided on one of the two opposed surfaces of the negative electrode current collector 22A on a side where the negative electrode 22 is opposed to the positive electrode 21. A method of forming the negative electrode active material layer 22B is not particularly limited, and may include any one or more of methods including, without limitation, a coating method, a vapor-phase method, a liquid-phase method, a thermal spraying method, a firing method, and a sintering method.

The negative electrode active material is not particularly limited in kind, and non-limiting examples thereof may include a carbon material and a metal-based material. One reason for this is that this helps to achieve a high energy density. Non-limiting examples of the carbon material may include graphitizable carbon, non-graphitizable carbon, and graphite such as natural graphite or artificial graphite. The metal-based material may be a material including, as one or more constituent elements, any one or more elements among metal elements and metalloid elements that are each able to form an alloy with lithium. Non-limiting examples of such metal elements and metalloid elements may include silicon and tin. The metal-based material may be, for example but not limited to, a simple substance, an alloy, a compound, a mixture of two or more thereof, or a material including two or more phases thereof. Non-limiting examples of the metal-based material may include TiSi₂ and SiOₓ (0<x≤2 or 0.2<x<1.4).

Details of the negative electrode binder may be similar to those of the positive electrode binder. Details of the negative electrode conductor may be similar to those of the positive electrode conductor.

The separator 23 may be an insulating porous film interposed between the positive electrode 21 and the negative electrode 22 as illustrated in FIG. 2, and may allow lithium ions to pass therethrough while preventing contact or a short circuit between the positive electrode 21 and the negative electrode 22. The separator 23 may include a polymer compound such as polyethylene.

The positive electrode 21, the negative electrode 22, and the separator 23 may each be impregnated with the electrolytic solution, and the electrolytic solution has the configuration described above. In other words, the electrolytic solution includes the lithium salt and the sulfonyl compound.

As illustrated in FIGS. 1 and 2, the positive electrode lead 31 may be a positive electrode terminal coupled to the positive electrode current collector 21A of the positive electrode 21, and may be led from an inside to an outside of the outer package film 10. The positive electrode lead 31 may include an electrically conductive material such as a metal material. Non-limiting examples of the electrically conductive material may include aluminum. The positive electrode lead 31 is not particularly limited in shape, and may have any of shapes including, without limitation, a thin plate shape and a meshed shape.

As illustrated in FIGS. 1 and 2, the negative electrode lead 32 may be a negative electrode terminal coupled to the negative electrode current collector 22A of the negative electrode 22, and may be led from the inside to the outside of the outer package film 10. The negative electrode lead 32 may include an electrically conductive material such as a metal material. Non-limiting examples of the electrically conductive material may include copper. For example, the negative electrode lead 32 may be led in a direction similar to that in which the positive electrode lead 31 is led. Note that details of a shape of the negative electrode lead 32 may be similar to those of the shape of the positive electrode lead 31.

The sealing film 41 may be interposed between the outer package film 10 and the positive electrode lead 31. The sealing film 42 may be interposed between the outer package film 10 and the negative electrode lead 32. In an embodiment, the sealing film 41, the sealing film 42, or both may be omitted.

The sealing film 41 may be a sealing member that prevents entry of, for example but not limited to, outside air into the outer package film 10. The sealing film 41 may include a polymer compound such as a polyolefin that has adherence to the positive electrode lead 31. Non-limiting examples of the polyolefin may include polypropylene.

A configuration of the sealing film 42 may be similar to that of the sealing film 41 except that the sealing film 42 is a sealing member that has adherence to the negative electrode lead 32. For example, the sealing film 42 may include a polymer compound such as a polyolefin that has adherence to the negative electrode lead 32.

Upon charging the secondary battery 1, in the battery device 20, lithium may be extracted from the positive electrode 21, and the extracted lithium may be inserted into the negative electrode 22 via the electrolytic solution. Upon discharging the secondary battery 1, in the battery device 20, lithium may be extracted from the negative electrode 22, and the extracted lithium may be inserted into the positive electrode 21 via the electrolytic solution. Upon the charging and the discharging, lithium may be inserted and extracted in an ionic state.

When manufacturing the secondary battery 1, the positive electrode 21 and the negative electrode 22 may each be fabricated, and the secondary battery 1 may be assembled with the positive electrode 21, the negative electrode 22, and the electrolytic solution, following which the secondary battery 1 may be subjected to a stabilization process, according to an example procedure to be described below. Note that the procedure for preparing the electrolytic solution may be as described above.

First, a mixture (i.e., a positive electrode mixture) in which the positive electrode active material, the positive electrode binder, and the positive electrode conductor are mixed with each other may be put into a solvent to thereby prepare a positive electrode mixture slurry in paste form. The solvent may be an aqueous solvent, or may be an organic solvent. Thereafter, the positive electrode mixture slurry may be applied on the two opposed surfaces of the positive electrode current collector 21A to thereby form the positive electrode active material layers 21B. Thereafter, the positive electrode active material layers 21B may be compression-molded by means of an apparatus such as a roll pressing machine. In an embodiment, the positive electrode active material layers 21B may be heated. In an embodiment, the positive electrode active material layers 21B may be compression-molded multiple times. The positive electrode active material layers 21B may thus be formed on the two respective opposed surfaces of the positive electrode current collector 21A. As a result, the positive electrode 21 may be fabricated.

The negative electrode 22 may be formed by a procedure similar to the fabrication procedure of the positive electrode 21 described above. For example, first, a mixture (i.e., a negative electrode mixture) in which the negative electrode active material, the negative electrode binder, and the negative electrode conductor are mixed with each other may be put into a solvent to thereby prepare a negative electrode mixture slurry in paste form. Details of the solvent may be as described above. Thereafter, the negative electrode mixture slurry may be applied on the two opposed surfaces of the negative electrode current collector 22A to thereby form the negative electrode active material layers 22B. Thereafter, the negative electrode active material layers 22B may be compression-molded. The negative electrode active material layers 22B may thus be formed on the two respective opposed surfaces of the negative electrode current collector 22A. As a result, the negative electrode 22 may be fabricated.

First, the positive electrode lead 31 may be coupled to the positive electrode current collector 21A of the positive electrode 21 by a joining method such as a welding method, and the negative electrode lead 32 may be coupled to the negative electrode current collector 22A of the negative electrode 22 by a joining method such as a welding method.

Thereafter, the positive electrode 21 and the negative electrode 22 may be stacked on each other with the separator 23 interposed therebetween, following which the stack of the positive electrode 21, the negative electrode 22, and the separator 23 may be wound to thereby fabricate a wound body (not illustrated). The wound body may have a configuration similar to that of the battery device 20, except that the positive electrode 21, the negative electrode 22, and the separator 23 are each not impregnated with the electrolytic solution. Thereafter, the wound body may be pressed by an apparatus such as a pressing machine to thereby shape the wound body into an elongated shape.

Thereafter, the wound body may be placed inside the depression part 10U, following which the outer package film 10 including a stack of the fusion-bonding layer, the metal layer, and the surface protective layer may be folded to thereby cause portions of the outer package film 10 to be opposed to each other. Thereafter, outer edge parts of two sides of the fusion-bonding layer opposed to each other may be bonded to each other by a bonding method such as a thermal-fusion-bonding method to thereby allow the wound body to be contained inside the outer package film 10 having a pouch shape.

Thereafter, the electrolytic solution may be injected into the outer package film 10 having the pouch shape, following which outer edge parts of the remaining one side of the fusion-bonding layer opposed to each other may be bonded to each other by a bonding method such as a thermal-fusion-bonding method. In this case, the sealing film 41 may be interposed between the outer package film 10 and the positive electrode lead 31, and the sealing film 42 may be interposed between the outer package film 10 and the negative electrode lead 32.

The wound body may thus be impregnated with the electrolytic solution, and the battery device 20 that is a wound electrode body may thus be fabricated. Accordingly, the battery device 20 may be sealed in the outer package film 10 having the pouch shape. As a result, the secondary battery 1 may be assembled.

The assembled secondary battery 1 may be charged and discharged. Various conditions including, for example but not limited to, an environment temperature, the number of times of charging and discharging (i.e., the number of cycles), and charging and discharging conditions may be set as desired. As a result, a film may be formed on the surface of each of the positive electrode 21 and the negative electrode 22, which may electrochemically stabilize a state of the secondary battery 1. As a result, the secondary battery 1 may be completed.

According to the secondary battery 1, the secondary battery 1 includes the electrolytic solution, and the electrolytic solution has the above-described configuration. This helps to achieve a secondary battery having a superior battery characteristic with use of the electrolytic solution, for any of the reasons described above. Non-limiting examples of the battery characteristic may include a capacity characteristic and a cyclability characteristic.

In an embodiment, the secondary battery 1 may include a lithium-ion secondary battery. This helps to obtain a sufficient battery capacity stably through insertion and extraction of lithium, which helps to achieve higher effects.

Other action and example effects of the secondary battery 1 may be similar to those of the electrolytic solution described above.

The configuration of the secondary battery 1 described above is appropriately modifiable as described below. Note that any of the following series of modification examples may be combined with each other.

In the secondary battery 1 according to an embodiment described above, the separator 23 that is a porous film may be used. In an embodiment, however, a separator of a stacked type including a polymer compound layer may be used although not illustrated here.

For example, the separator of the stacked type may include a porous film having two opposed surfaces, and the polymer compound layer provided on one of or each of the two opposed surfaces of the porous film. One reason for this is that this helps to improve adherence of the separator to each of the positive electrode 21 and the negative electrode 22, which helps to suppress misalignment (e.g., winding displacement) of the battery device 20. This helps to suppress swelling of the secondary battery even if a side reaction such as the decomposition reaction of the electrolytic solution occurs. The polymer compound layer may include a polymer compound such as polyvinylidene difluoride. One reason for this is that this helps to achieve superior physical strength and superior electrochemical stability.

In an embodiment, the porous film, the polymer compound layer, or both may each include any one or more kinds of insulating particles. One reason for this is that the insulating particles promote heat dissipation upon heat generation by the secondary battery, which helps to improve safety or heat resistance of the secondary battery. The insulating particles may include an inorganic material, a resin material, or both. Non-limiting examples of the inorganic material may include aluminum oxide, aluminum nitride, boehmite, silicon oxide, titanium oxide, magnesium oxide, and zirconium oxide. Non-limiting examples of the resin material include acrylic resin and styrene resin.

When fabricating the separator of the stacked type, a precursor solution including, for example but not limited to, the polymer compound and a solvent may be prepared, following which the precursor solution may be applied on one of or each of the two opposed surfaces of the porous film. In an embodiment, the insulating particles may be added to the precursor solution on an as-needed basis.

When the separator of the stacked type is used also, lithium ions are movable between the positive electrode 21 and the negative electrode 22. This helps to achieve similar effects. For example, it helps to improve safety of the secondary battery, as described above, and thus helps to achieve higher effects.

In the secondary battery 1 according to an embodiment described above, the electrolytic solution, which is a liquid electrolyte, may be used. In an embodiment, however, an electrolyte layer, which is a gel electrolyte, may be used although not illustrated here.

In the battery device 20 including the electrolyte layer, the positive electrode 21 and the negative electrode 22 may be stacked on each other with the separator 23 and the electrolyte layer interposed therebetween, and the stack of the positive electrode 21, the negative electrode 22, the separator 23, and the electrolyte layer may be wound. The electrolyte layer may be interposed between the positive electrode 21 and the separator 23, and between the negative electrode 22 and the separator 23.

For example, the electrolyte layer may include a polymer compound together with the electrolytic solution, and the electrolytic solution may be held by the polymer compound. One reason for this is that this helps to prevent leakage of the electrolytic solution. The configuration of the electrolytic solution may be as described above. The polymer compound may include a material such as polyvinylidene difluoride. When forming the electrolyte layer, a precursor solution including, for example but not limited to, the electrolytic solution, the polymer compound, and a solvent may be prepared, following which the precursor solution may be applied on one side or both sides of the positive electrode 21 and on one side or both sides of the negative electrode 22.

When the electrolyte layer is used also, lithium ions are movable between the positive electrode 21 and the negative electrode 22 via the electrolyte layer. This helps to achieve similar effects. For example, it helps to prevent the leakage of the electrolytic solution as described above, which helps to achieve higher effects.

Applications of the secondary battery are not particularly limited. The secondary battery used as a power source may serve as a main power source or an auxiliary power source in, for example but not limited to, electronic equipment, an electric vehicle, or any other application in which any embodiment of the present disclosure is usable. The main power source may be preferentially used regardless of the presence of any other power source. The auxiliary power source may be used in place of the main power source, or may be switched from the main power source on an as-needed basis.

Non-limiting examples of the applications of the secondary battery may include: electronic equipment; apparatuses for data storage; electric power tools; battery packs to be mounted on, for example but not limited to, electronic equipment; medical electronic equipment; electric vehicles; and electric power storage systems. Non-limiting examples of the electronic equipment may include video cameras, digital still cameras, mobile phones, laptop personal computers, headphone stereos, portable radios, portable information terminals, and any other electronic equipment to which any embodiment of the present disclosure is applicable. Non-limiting examples of the apparatuses for data storage may include backup power sources, memory cards, and any other apparatus for data storage to which any embodiment of the present disclosure is applicable. Non-limiting examples of the electric power tools may include electric drills, electric saws, and any other electric power tool to which any embodiment of the present disclosure is applicable. Non-limiting examples of the medical electronic equipment may include pacemakers, hearing aids, and any other medical electronic equipment to which any embodiment of the present disclosure is applicable. Non-limiting examples of the electric vehicle may include electric automobiles including hybrid electric automobiles, and any other electric vehicle to which any embodiment of the present disclosure is applicable. Non-limiting examples of the electric power storage systems may include battery systems for home use or industrial use in which electric power is accumulated for a situation such as emergency, and any other electric power storage system to which any embodiment of the present disclosure is applicable. In each of the above-described application examples, one secondary battery may be used, or multiple secondary batteries may be used.

The battery packs may each include a single battery, or may each include an assembled battery. The electric vehicle may be a vehicle that operates or travels with the secondary battery as a driving power source, and may be a hybrid automobile that is additionally provided with a driving source other than the secondary battery. In the electric power storage system for home use, electric power accumulated in the secondary battery that is an electric power storage source may be utilized for using, for example but not limited to, home appliances and any other electrical appliance.

One application example of the secondary battery will now be described in detail. The configuration of the application example described below is merely an example, and is appropriately modifiable.

FIG. 3 illustrates a block configuration of a battery pack. The battery pack described here may be a battery pack including one secondary battery, and may be mounted on, for example but not limited to, electronic equipment such as a smartphone. In this example, the battery pack may be what is called a soft pack.

As illustrated in FIG. 3, the battery pack may include an electric power source 51 and a circuit board 52. The circuit board 52 may be coupled to the electric power source 51, and may include a positive electrode terminal 53, a negative electrode terminal 54, and a temperature detection terminal 55.

The electric power source 51 may include one secondary battery. The secondary battery may have a positive electrode lead coupled to the positive electrode terminal 53 and a negative electrode lead coupled to the negative electrode terminal 54. The electric power source 51 may be couplable to outside via the positive electrode terminal 53 and the negative electrode terminal 54, and may thus be chargeable and dischargeable. The circuit board 52 may include a processor 56, a switch 57, a positive temperature coefficient (PTC) device 58, and a temperature detector 59. In an embodiment, the PTC device 58 may be omitted.

The processor 56 may include, for example but not limited to, a central processing unit (CPU) and a memory, and may control an overall operation of the battery pack. The processor 56 may detect and control a use state of the electric power source 51 on an as-needed basis.

If a voltage of the electric power source 51 (i.e., the secondary battery) reaches an overcharge detection voltage or an overdischarge detection voltage, the processor 56 may turn off the switch 57. This prevents a charging current from flowing into a current path of the electric power source 51. The overcharge detection voltage is not particularly limited, and may be 4.20 V±0.05 V, for example. The overdischarge detection voltage is not particularly limited, and may be 2.40 V±0.1 V, for example.

The switch 57 may include, for example but not limited to, a charge control switch, a discharge control switch, a charging diode, and a discharging diode. The switch 57 may perform switching between coupling and decoupling between the electric power source 51 and external equipment in accordance with an instruction from the processor 56. The switch 57 may include, for example but not limited to, a metal-oxide-semiconductor field-effect transistor (MOSFET). The charging and discharging currents may be detected based on an ON-resistance of the switch 57.

The temperature detector 59 may include a temperature detection device such as a thermistor. The temperature detector 59 may measure a temperature of the electric power source 51 through the temperature detection terminal 55, and may output a result of the temperature measurement to the processor 56. The result of the temperature measurement to be obtained by the temperature detector 59 may be used, for example but not limited to, when the processor 56 performs charge/discharge control upon abnormal heat generation or when the processor 56 performs a correction process upon calculating a remaining capacity.

### EXAMPLES

A description is given below of Examples of an embodiment of the present disclosure.

### Examples 1 to 9 and Comparative Examples 1 to 4

Electrolytic solutions were manufactured, following which the electrolytic solutions were evaluated for their characteristic as described below.

### [Manufacturing of Electrolytic Solution]

The electrolyte salt (i.e., the lithium salt) was added to the solvent (i.e., the sulfonyl compound), following which the solvent was stirred.

As the cyclic compound of the sulfonyl compound, sulfolane (SL) and 3-methylsulfolane (MSL) were used. As the chain compound of the sulfonyl compound, dimethyl sulfone (DMS) and ethyl methyl sulfone (EMS) were used. The sulfonyl compound had the composition indicated in Table 1. Here, two selected from the cyclic compounds and the chain compounds were used as the sulfonyl compound.

As the lithium salt, bis(fluorosulfonyl)imide lithium (LiFSI) was used.

In this case, a mixture ratio between the lithium salt and the sulfonyl compound was set as indicated in Table 1. The molar ratio M was changed by changing respective amounts of substance (mol) of the lithium salt and the sulfonyl compound (i.e., the two selected from the cyclic compounds and the chain compounds).

The electrolytic solution including the lithium salt and the sulfonyl compound was thus prepared.

An electrolytic solution for comparison was prepared by a similar procedure, except that only one of the cyclic compound or the chain compound was used as the sulfonyl compound as indicated in Table 1.

### [Characteristic Evaluation of Electrolytic Solution]

Evaluation of the electrolytic solutions for their characteristics or states revealed the results presented in Table 1.

For evaluation, the mixture obtained by the above-described manufacturing procedure of the electrolytic solution was stored in a freezer (at a temperature of −10° C. for a storage time of one week), following which the state of the mixture, i.e., whether the mixture was liquid or solid, was visually checked.

For reference, Table 1 also presents a concentration (mol/dm³ (=mol/1)), a density (g/cm³), a viscosity (mPa·s), and ion conductivity (mS/cm) of the mixture. The concentration was a content of the electrolyte salt (i.e., the lithium salt) relative to the solvent (i.e., the sulfonyl compound). The density and the viscosity were each measured by means of a viscometer (Stabinger kinematic viscometer SVM 3000 available from Anton Paar GmbH located in Graz, Austria). In addition, the ion conductivity was measured by an alternating-current impedance method by coupling an alternating-current impedance measuring apparatus (an alternating-current impedance measuring apparatus VMP3 available from BioLogic located in Seyssinet-Pariset, France) to an electric conductivity cell (an electric conductivity cell CG-511B available from DKK-TOA Corporation located in Tokyo, Japan).

TABLE 1

| | Lithium salt | | Sulfonyl compound | | | | | | | | | |
|---|---|---|---|---|---|---|---|---|---|---|---|---|
| | | Amount of | | Amount of | | Amount of | Molar | | | | | |
| | | substance | Cyclic | substance | Chain | substance | ratio | Concen- | | | Ion | |
| | Kind | (mol) | compound | (mol) | compound | (mol) | M | tration | Density | Viscosity | conductivity | State |
| Example 1 | LiFSI | 1 | SL + MSL | 1 + 1 | — | — | 2 | 3.354 | 1.4803 | 293.07 | 1.147 | Liquid |
| Example 2 | LiFSI | 1 | SL + MSL | 1.5 + 1.5 | — | — | 3 | 2.606 | 1.4819 | 134.85 | 1.684 | Liquid |
| Example 3 | LiFSI | 1 | SL + MSL | 2 + 2 | — | — | 4 | 1.976 | 1.3747 | 81.61 | 2.155 | Liquid |
| Example 4 | LiFSI | 1 | SL | 1 | DMS | 1 | 2 | 3.820 | 1.5333 | 270.64 | 1.563 | Liquid |
| Example 5 | LiFSI | 1 | SL | 1.5 | DMS | 1.5 | 3 | 2.881 | 1.4648 | 118.54 | 2.278 | Liquid |
| Example 6 | LiFSI | 1 | SL | 2 | DMS | 2 | 4 | 2.312 | 1.4231 | 67.89 | 2.810 | Liquid |
| Example 7 | LiFSI | 1 | SL | 1 | EMS | 1 | 2 | 3.592 | 1.4922 | 258.73 | 1.330 | Liquid |
| Example 8 | LiFSI | 1 | SL | 1.5 | EMS | 1.5 | 3 | 2.689 | 1.4240 | 117.47 | 1.880 | Liquid |
| Example 9 | LiFSI | 1 | SL | 2 | EMS | 2 | 4 | 2.148 | 1.3828 | 67.67 | 2.559 | Liquid |
| Comparative | LiFSI | 1 | SL | 3 | — | — | 3 | 2.660 | 1.4583 | 121.00 | 2.190 | Solid |
| example 1 | | | | | | | | | | | | |
| Comparative | LiFSI | 1 | SL | 4 | — | — | 4 | 2.130 | 1.4197 | 74.00 | 2.650 | Solid |
| example 2 | | | | | | | | | | | | |
| Comparative | LiFSI | 1 | — | — | DMS | 3 | 3 | 3.140 | 1.4740 | 119.00 | 2.400 | Solid |
| example 3 | | | | | | | | | | | | |
| Comparative | LiFSI | 1 | — | — | DMS | 4 | 4 | — | — | — | — | Solid |
| example 4 | | | | | | | | | | | | |

※Units: concentration (mol/dm³), density (g/cm³), viscosity (mPa · s), ion conductivity (mS/cm)

As indicated in Table 1, the state of the mixture varied depending on the configuration of the mixture.

When only one sulfonyl compound was used as the solvent (i.e., Comparative examples 1 to 4), the state of the mixture was solid. When the chain compound was used as the sulfonyl compound, a part of the mixture was already solid at room temperature depending on the molar ratio M. In such a case, each of the concentration, the density, the viscosity, and the ion conductivity was not measured.

In contrast, when two sulfonyl compounds were used as the solvent and the molar ratio M was set to be within the range from 2 to 4 both inclusive (i.e., Examples 1 to 9), the state of the mixture was liquid, and the mixture was thus a liquid electrolyte, i.e., an electrolytic solution.

In this case (Examples 1 to 9), a series of tendencies described below were obtained.

One tendency was that when two cyclic compounds were used as the sulfonyl compound (i.e., Examples 1 to 3), the state of the mixture was stably liquid. In this case, if one of the cyclic compounds was sulfolane (SL) and another of the cyclic compounds was the derivative of sulfolane (MSL), the state of the mixture was sufficiently stably liquid.

Another tendency was that when one cyclic compound and one chain compound were used as the sulfonyl compound (i.e., Examples 4 to 9), the state of the mixture was stably liquid. In this case, if the cyclic compound was sulfolane (SL) and the chain compound was either dimethyl sulfone (DMS) or ethyl methyl sulfone (EMS), the state of the mixture was sufficiently stably liquid.

### Examples 10 to 14

Electrolytic solutions were each manufactured by a procedure similar to the procedure in each of Examples 2 and 5 except that the fluorinated ether compound was further added to the solvent (i.e., the sulfonyl compound) as indicated in Table 2, and the electrolytic solutions were evaluated for their characteristics.

Here, hydrofluoroether (CHF₂—CF₂—O—CH₂—CF₂—CHF₂ (HFE)) was used as the fluorinated ether compound. An amount of substance (mol), i.e., an added amount of the fluorinated ether compound was as indicated in Table 2.

TABLE 2
Lithium salt (kind = LiFSI, amount of substance = 1 mol)

| | | | | | Fluorinated ether | | | | | | | |
|---|---|---|---|---|---|---|---|---|---|---|---|---|
| | Sulfonyl compound | | | | compound | | | | | | | |
| | | Amount of | | Amount of | | Amount of | Molar | | | | | |
| | Cyclic | substance | Chain | substance | | substance | ratio | Concen- | | | Ion | |
| | compound | (mol) | compound | (mol) | Kind | (mol) | M | tration | Density | Viscosity | conductivity | State |
| Example 2 | SL + MSL | 1.5 + 1.5 | — | — | — | — | 3 | 2.606 | 1.4819 | 134.85 | 1.684 | Liquid |
| Example 10 | SL + MSL | 1.5 + 1.5 | — | — | HFE | 1 | 3 | 1.816 | 1.4539 | 39.23 | 2.320 | Liquid |
| Example 11 | SL + MSL | 1.5 + 1.5 | — | — | HFE | 2 | 3 | 1.428 | 1.4752 | 18.46 | 2.370 | Liquid |
| Example 12 | SL + MSL | 1.5 + 1.5 | — | — | HFE | 3 | 3 | 1.159 | 1.4659 | 12.12 | 2.520 | Liquid |
| Example 5 | SL | 1.5 | DMS | 1.5 | — | — | 3 | 2.881 | 1.4648 | 118.54 | 2.278 | Liquid |
| Example 13 | SL | 1.5 | DMS | 1.5 | HFE | 1 | 3 | 2.025 | 1.4993 | 36.76 | 2.630 | Liquid |
| Example 14 | SL | 1.5 | DMS | 1.5 | HFE | 2 | 3 | 1.555 | 1.5123 | 18.23 | 2.520 | Liquid |

※Units: concentration (mol/dm³), density (g/cm³), viscosity (mPa · s), ion conductivity (mS/cm)

As indicated in Table 2, when the fluorinated ether compound was used (i.e., Examples 10 to 14) also, the state of the mixture was liquid. Accordingly, a liquid electrolyte, i.e., an electrolytic solution was obtained.

In this case, the viscosity decreased and the ion conductivity increased, as compared with when no fluorinated ether compound was used (Examples 2 and 5).

### Example 15

As described below, a test secondary battery was manufactured with the electrolytic solution of Example 13, following which the test secondary battery was evaluated for its battery characteristic.

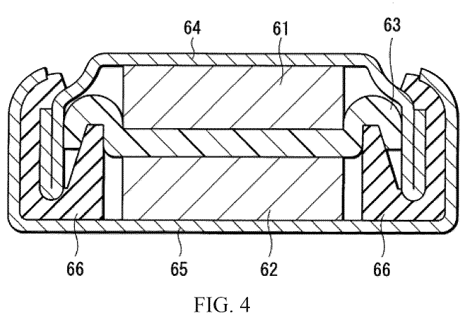

FIG. 4 illustrates a sectional configuration of the test secondary battery. The test secondary battery was a lithium-ion secondary battery of what is called a coin type. As illustrated in FIG. 4, in the test secondary battery, a test electrode 61 was placed inside an outer package cup 64, and a counter electrode 62 was placed inside an outer package can 65. The test electrode 61 and the counter electrode 62 were stacked on each other with a separator 63 interposed therebetween, and the outer package cup 64 and the outer package can 65 were crimped to each other with a gasket 66 interposed therebetween. The test electrode 61, the counter electrode 62, and the separator 63 were each impregnated with the electrolytic solution.

### [Manufacturing of Secondary Battery]

When fabricating the test electrode 61, first, 90 parts by mass of the positive electrode active material (LiNi_{0.8}Co_{0.15}Al_{0.05}O₂ as the lithium-containing compound (an oxide)), 5 parts by mass of the positive electrode binder (polyvinylidene difluoride), and 5 parts by mass of the positive electrode conductor (Ketjen black) were mixed with each other to thereby obtain a positive electrode mixture. Thereafter, the positive electrode mixture was put into a solvent (N-methyl-2-pyrrolidone as the organic solvent), following which the solvent was stirred to thereby prepare a positive electrode mixture slurry in paste form. Thereafter, the positive electrode mixture slurry was applied on one of the two opposed surfaces of the positive electrode current collector (an aluminum foil having a thickness of 15 μm) by means of a coating apparatus, following which the applied positive electrode mixture slurry was dried to thereby form the positive electrode active material layer. Thereafter, the positive electrode active material layer was compression-molded by means of a roll pressing machine.

When fabricating the counter electrode 62, first, 90 parts by mass of the negative electrode active material (a simple substance of silicon as the metal-based material), 5 parts by mass of the negative electrode binder (polyvinylidene difluoride), and 5 parts by mass of the negative electrode conductor (Ketjen black) were mixed with each other to thereby obtain a negative electrode mixture. Thereafter, the negative electrode mixture was put into a solvent (N-methyl-2-pyrrolidone as the organic solvent), following which the solvent was stirred to thereby prepare a negative electrode mixture slurry in paste form. Thereafter, the negative electrode mixture slurry was applied on one of the two opposed surfaces of the negative electrode current collector (a copper foil having a thickness of 15 m) by means of a coating apparatus, following which the applied negative electrode mixture slurry was dried to thereby form the negative electrode active material layer. Thereafter, the negative electrode active material layer was compression-molded by means of a roll pressing machine.

When preparing the electrolytic solution, a procedure similar to that of Example 13 was used, except that the fluorinated cyclic carbonic acid ester was further added to the solvent (i.e., the sulfonyl compound) on an as-needed basis. As the fluorinated cyclic carbonic acid ester, monofluoroethylene carbonate (FEC) was used. An amount of substance (mol), i.e., an added amount of the fluorinated cyclic carbonic acid ester was as indicated in Table 3.

When assembling the secondary battery, first, the test electrode 61 was punched into a pellet shape, following which the test electrode 61 was placed inside the outer package cup 64. Thereafter, the counter electrode 62 was punched into a pellet shape, following which the counter electrode 62 was placed inside the outer package can 65. Thereafter, the test electrode 61 placed inside the outer package cup 64 and the counter electrode 62 placed inside the outer package can 65 were stacked on each other with the separator 63 (a porous polyolefin film having a thickness of 7 m) impregnated with the electrolytic solution interposed therebetween. Thereafter, the outer package cup 64 and the outer package can 65 were crimped to each other with the gasket 66 interposed therebetween.

When stabilizing the assembled secondary battery, the secondary battery was charged and discharged for one cycle in an ambient temperature environment (at a temperature of 23° C.). Upon charging, the secondary battery was charged with a constant current at a current density of 1 mA/cm² until a voltage reached 4.2 V, and was thereafter charged with a constant voltage of that value, i.e., 4.2 V, until a current density reached 0.02 mA/cm². Upon discharging, the secondary battery was discharged with a constant current at a current density of 1 mA/cm² until the voltage reached 3.0 V.

The test secondary battery illustrated in FIG. 4 was thus completed.

### [Evaluation of Battery Characteristic]

The secondary battery was evaluated for its cyclability characteristic as its battery characteristic, which revealed the results presented in Table 3.

In this case, first, the secondary battery was charged and discharged in an ambient temperature environment to thereby measure a discharge capacity (a first-cycle discharge capacity). Thereafter, the secondary battery was repeatedly charged and discharged in the same environment until the total number of cycles reached 50 to thereby measure a discharge capacity (a 50th-cycle discharge capacity) again. Thereafter, a capacity retention rate that was an index for evaluating the cyclability characteristic was calculated based on the following calculation expression: capacity retention rate (%)=(50th-cycle discharge capacity/first-cycle discharge capacity)×100. Note that charging and discharging conditions were set to be similar to those for stabilization of the secondary battery.

TABLE 3
Lithium salt (kind = LiFSI, amount of substance = 1 mol)

| | | | | | | | Fluorinated cyclic | | | | |
|---|---|---|---|---|---|---|---|---|---|---|---|
| | | | | | Fluorinated ether | | carbonic acid | | | | |
| | Sulfonyl compound | | | | compound | | ester | | | | Capacity |
| | | Amount of | | Amount of | | Amount of | | Amount of | Molar | | retention |
| | Cyclic | substance | Chain | substance | | substance | | substance | ratio | | rate |
| | compound | (mol) | compound | (mol) | Kind | (mol) | Kind | (mol) | M | State | (%) |
| Example 13 | SL | 1.5 | DMS | 1.5 | HFE | 1 | — | — | 3 | Liquid | 87 |
| Example 15 | SL | 1.5 | DMS | 1.5 | HFE | 1 | FEC | 1 | 3 | Liquid | 96 |

As indicated in Table 3, when the electrolytic solution including the lithium salt and the sulfonyl compound was used (Example 13), a high capacity retention rate was obtained. In this case, if the electrolytic solution included the fluorinated cyclic carbonic acid ester (Example 15), the capacity retention rate further increased.

Based upon the results presented in Tables 1 to 3, when: the electrolytic solution included the lithium salt and the sulfonyl compound; the sulfonyl compound included two or more selected from the cyclic compounds and the chain compounds; and the molar ratio M was within the range from 2 to 4 both inclusive, the liquid state of the electrolytic solution was achieved. This allowed the mixture of the lithium salt and the sulfonyl compound to be used as a liquid electrolyte, i.e., an electrolytic solution. This made it possible to achieve a secondary battery having a superior battery characteristic with use of the electrolytic solution.

Although the present disclosure has been described herein with reference to embodiments including Examples, the configuration of an embodiment of the present disclosure is not limited thereto, and is therefore modifiable in a variety of ways.

For example, the description has been given of the example case where the secondary battery has a battery structure of the laminated-film type. However, the battery structure of the secondary battery is not particularly limited, and may be, for example but not limited to, of a cylindrical type, a prismatic type, a button type, or any type applicable to the secondary battery.

Further, the description has been given of the example case where the battery device has a device structure of a wound type. However, the device structure of the battery device is not particularly limited, and may be, for example but not limited to, of a stacked type or a zigzag folded type. In the stacked type, the positive electrode and the negative electrode may be alternately stacked on each other with the separator interposed therebetween. In the zigzag folded type, the positive electrode and the negative electrode may be opposed to each other with the separator interposed therebetween, and may be folded in a zigzag manner.

Further, although the description has been given of the example case where the electrode reactant is lithium, the electrode reactant is not particularly limited. In an embodiment, the electrode reactant may be another alkali metal such as sodium or potassium, or may be an alkaline earth metal such as beryllium, magnesium, or calcium, as described above. In an embodiment, the electrode reactant may be another light metal such as aluminum.

The effects described herein are mere examples, and effects of an embodiment of the present disclosure are therefore not limited to those described herein. Accordingly, an embodiment of the present disclosure may achieve any other effect.

Furthermore, the present disclosure encompasses any possible combination of some or all of the various embodiments and the modification examples described herein and incorporated herein. It is possible to achieve at least the following configurations from the above-described embodiments of the present disclosure.

(1)

An electrolytic solution for a secondary battery, the electrolytic solution including:
a lithium salt;
a sulfonyl compound including two or more selected from cyclic compounds and chain compounds, the sulfonyl compound including at least one of the cyclic compounds, each of the cyclic compounds being represented by Formula (1), each of the chain compounds being represented by Formula (2); and
a fluorinated ether compound represented by Formula (3), in which
a concentration of the lithium salt is higher than or equal to 1.159 moles per liter and lower than or equal to 3.592 moles per liter, and
a ratio of a number of moles of the sulfonyl compound to a number of moles of the lithium salt is greater than or equal to 2 and less than or equal to 4,

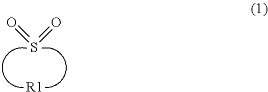

where R1 is an alkylene group,

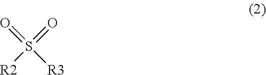

where each of R2 and R3 is an alkyl group,

R4-O—R5 (3)

where each of R4 and R5 is a fluorinated alkyl group.

(2)

The electrolytic solution for a secondary battery according to (1), in which the sulfonyl compound includes two of the cyclic compounds.

(3)

The electrolytic solution for a secondary battery according to (2), in which the sulfonyl compound includes sulfolane.

(4)

The electrolytic solution for a secondary battery according to (3), in which the sulfonyl compound further includes 3-methylsulfolane.

(5)

The electrolytic solution for a secondary battery according to (1), in which the sulfonyl compound includes one of the cyclic compounds and one of the chain compounds.

(6)

The electrolytic solution for a secondary battery according to (5), in which the sulfonyl compound includes sulfolane.

(7)

The electrolytic solution for a secondary battery according to (6), in which the sulfonyl compound further includes dimethyl sulfone, ethyl methyl sulfone, or both.

(8)

The electrolytic solution for a secondary battery according to any one of (1) to (7), further including a fluorinated cyclic carbonic acid ester.

(9)

The electrolytic solution for a secondary battery according to (1), in which the concentration of the lithium salt is higher than or equal to 1.159 moles per liter and lower than or equal to 3.354 moles per liter.

(10)

The electrolytic solution for a secondary battery according to (1), in which the concentration of the lithium salt is higher than or equal to 1.159 moles per liter and lower than or equal to 2.025 moles per liter.

(11)

A secondary battery including:
a positive electrode;
a negative electrode; and
the electrolytic solution for a secondary battery according to any one of (1) to (10).

(12)

The secondary battery according to (11), in which the secondary battery includes a lithium-ion secondary battery.

According to an electrolytic solution for a secondary battery of at least an embodiment of the present disclosure and a secondary battery of at least an embodiment of the present disclosure, the electrolytic solution for a secondary battery includes a lithium salt and a sulfonyl compound, the sulfonyl compound includes two or more selected from cyclic compounds and chain compounds, each of the cyclic compounds is represented by Formula (1), each of the chain compounds is represented by Formula (2), and a ratio of a number of moles of the sulfonyl compound to a number of moles of the lithium salt is greater than or equal to 2 and less than or equal to 4. This helps to achieve a superior battery characteristic.

Note that effects of an embodiment of the present disclosure are not necessarily limited to the example effects described above and may include any of a series of effects described herein in relation to an embodiment of the present disclosure.

Although the present disclosure has been described hereinabove in terms of an embodiment and modification examples, the present disclosure is not limited thereto. It should be appreciated that variations may be made in the described example embodiment and modification examples by those skilled in the art without departing from the scope of the present disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An electrolytic solution for a secondary battery, the electrolytic solution comprising:
a lithium salt;
a sulfonyl compound including two or more selected from cyclic compounds and chain compounds, the sulfonyl compound including at least one of the cyclic compounds, each of the cyclic compounds being represented by Formula (1), each of the chain compounds being represented by Formula (2); and
a fluorinated ether compound represented by Formula (3), wherein
a concentration of the lithium salt is higher than or equal to 1.159 moles per liter and lower than or equal to 3.592 moles per liter, and
a ratio of a number of moles of the sulfonyl compound to a number of moles of the lithium salt is greater than or equal to 2 and less than or equal to 4, 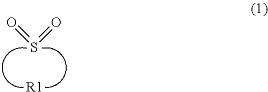
where R1 is an alkylene group, 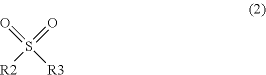
where each of R2 and R3 is an alkyl group,
R4-O—R5 (3)
where each of R4 and R5 is a fluorinated alkyl group.

2. The electrolytic solution for a secondary battery according to claim 1, wherein the sulfonyl compound includes two of the cyclic compounds.

3. The electrolytic solution for a secondary battery according to claim 2, wherein the sulfonyl compound includes sulfolane.

4. The electrolytic solution for a secondary battery according to claim 3, wherein the sulfonyl compound further includes 3-methylsulfolane.

5. The electrolytic solution for a secondary battery according to claim 1, wherein the sulfonyl compound includes one of the cyclic compounds and one of the chain compounds.

6. The electrolytic solution for a secondary battery according to claim 5, wherein the sulfonyl compound includes sulfolane.

7. The electrolytic solution for a secondary battery according to claim 6, wherein the sulfonyl compound further includes dimethyl sulfone, ethyl methyl sulfone, or both.

8. The electrolytic solution for a secondary battery according to claim 1, further comprising a fluorinated cyclic carbonic acid ester.

9. The electrolytic solution for a secondary battery according to claim 1, wherein the concentration of the lithium salt is higher than or equal to 1.159 moles per liter and lower than or equal to 3.354 moles per liter.

10. The electrolytic solution for a secondary battery according to claim 1, wherein the concentration of the lithium salt is higher than or equal to 1.159 moles per liter and lower than or equal to 2.025 moles per liter.

11. A secondary battery comprising:
a positive electrode;
a negative electrode; and
an electrolytic solution,
the electrolytic solution including
a lithium salt,
a sulfonyl compound including two or more selected from cyclic compounds and chain compounds, the sulfonyl compound including at least one of the cyclic compounds, each of the cyclic compounds being represented by Formula (1), each of the chain compounds being represented by Formula (2),
and
a fluorinated ether compound represented by Formula (3), wherein
a concentration of the lithium salt is higher than or equal to 1.159 moles per liter and lower than or equal to 3.592 moles per liter, and
a ratio of a number of moles of the sulfonyl compound to a number of moles of the lithium salt is greater than or equal to 2 and less than or equal to 4, 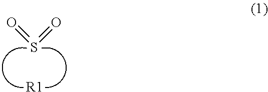
where R1 is an alkylene group, 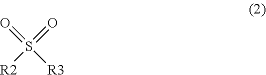
where each of R2 and R3 is an alkyl group,
R4-O—R5 (3)
where each of R4 and R5 is a fluorinated alkyl group.

12. The secondary battery according to claim 11, wherein the secondary battery comprises a lithium-ion secondary battery.
